(19) United States
(12) Patent Application Publication
(10) Pub. No.: US 2020/0042097 A1
(43) Pub. Date: Feb. 6, 2020

(54) HOLOGRAPHIC INTERFACE FOR MANIPULATION

(71) Applicant: WAYNE PATRICK O'BRIEN, STAUNTON, VA (US)

(72) Inventor: WAYNE PATRICK O'BRIEN, STAUNTON, VA (US)

(21) Appl. No.: 16/601,223

(22) Filed: Oct. 14, 2019

Related U.S. Application Data
(63) Continuation of application No. 14/736,208, filed on Jun. 10, 2015, now abandoned.

(51) Int. Cl. G06F 3/01; G03H 1/00

(52) U.S. Cl. CPC G06F 3/017; G03H 2001/0061; G03H 1/0005

(57) ABSTRACT

The holographic interface for manipulation includes a holographic display unit for constructing and displaying a hologram and a motion detector for detecting movement and location of a physical command object, such as a user's finger or hand, relative to the displayed hologram. The motion detector is in communication with a controller for converting the detected location of the physical command object relative to its position with respect to the displayed hologram into a command signal. The command signal is then transmitted to an external device, such as a robotic arm in a remote plant, or any other suitable external system. Alternatively, the hologram may be a holographic image of physical controls for an external system, for example, and the command signal may be a command for the external device to perform an act corresponding to manipulation of the holographic image of a physical control by the command object.

### CROSS REFERENCE TO RELATED APPLICATIONS

This application is a continuation of Ser. No. 14/736,208, filed Jun. 10, 2015, the priority of which is claimed.

### BACKGROUND OF THE INVENTION

### 1. Field of the Invention

The present invention relates to man-machine interfaces, and particularly to a holographic interface for manipulation that couples motion detection with a holographic display for providing a three-dimensional, interactive interface for controlling an external device, an external system, or for providing an interface with a computer system for running an application, a simulation or for transmitting control signals to the external device or system.

### 2. Description of the Related Art

Holographic interfaces for computers and the like are known. FIGS. 2 and 3 show an exemplary prior art holographic direct manipulation interface for enabling a user to input commands to a computer and display the desired output. As shown in FIG. 2, user 15 sits in front of a three-dimensional displayed hologram 25 positioned near a corresponding central processing unit (CPU) 10 or the like, which is in communication with a motion detector 35. The motion detector 35 monitors the location of a “command object” 17, such as the user's finger.

As shown in FIGS. 2 and 3, the prior art computer input system allows the user 15 to input a command to a computer 10 via a holographic display 25 or hologram by moving his or her finger to a location on the hologram. This location, referred to as a “command point” 27, is best shown in FIG. 3. The CPU 10 stores data that enables a holographic display unit 30 to generate a hologram 25. A motion detector 35 detects the movement of a command object 17. The command object 17 whose motion is detected may alternatively be designated as a finger on the user's hand or any other passively movable object, such as a pointer stick. The command object 17 may also transmit a signal or ray to the motion detector 35. CPU 10 compares the location of the command object 17 and its motion relative to the location of the command points 27 to determine whether a command is being selected by the user 15. When the command object 17 passes within a threshold distance of a command point 27 or performs a contact code, the selected command is performed.

When the computer is started and operating, a hologram 25 that is similar to the screen of a graphical user interface (GUI) is displayed before a user, but the display is in three dimensions. There is no monitor or other conventional display interface physically present; i.e., the conventional computer GUI is replaced by a holograph 25 that displays information. The hologram is projected in midair from a holographic display unit 30. As best seen in FIG. 3, the holographic display unit 30 displays three-dimensional objects, menu selections, and/or data points in all three dimensions, and this constitutes the hologram 25.

The user 15 is presented with a multitude of command points 27 in, on, and around the hologram 25 from which he or she can choose. The user 15 selects a command point 27, which is displayed as an object, menu selection, or data point in the three-dimensional display area. The command object 17 (the user's finger in the example of FIG. 3) is controlled by the user 15, and it is the instrument that enables the user 15 to communicate with the computer. The user 15 chooses where the command object 17 travels and the command points 27 desired to be selected. The user 15 moves the command object 17 to within a minimum threshold distance of a command point 27 or performs a “contact code” to choose a command. After a predetermined period programmed into the computer during which the command object is detected by the motion detector in that location, the command is initiated.

FIG. 3 displays an enlarged and detailed view of the hologram 25 and user 15 using his or her finger as the command object 17 to designate a command by moving the finger within a threshold distance of the command point 27. An object is designated as the command object 17 by user 15. The location of the command object 17 is continuously monitored by the motion detector 35. The command object's three-dimensional location is continuously sent as output signals to CPU 10 by the motion detector 35. The CPU 10 compares the location of the command object 17 to the stored data locations of displayed command points 27 in, on, and around the hologram 25 that is presently displayed. Moving the command object 17 within a minimum threshold distance of a displayed command point 27 on the hologram selects the command. The command selected by the user depends upon the command points 27 that are displayed in, on, or around the hologram and on which command point 27 the user moves his or her command object 17 within a minimum threshold distance of.

Predetermined sequences of motion are stored in the CPU 10, and these are referred to as “contact codes”. The locations of the command object 17 are monitored by the processor to determine whether a contact code is performed by it. For example, a tapping motion on or near a command point 27, similar to double-clicking with a mouse, indicates a command is sought to be implemented by the user 15.

The CPU 10 receives the signals that represent the location of the command object 17 and computes the distance between the command object 17 and command points 27.

The three-dimensional coordinates of all currently displayed command points 27 in, on, and around the hologram 25 are saved in the CPU 10. The saved locations of each command point 27 are continuously compared to the locations sent to the CPU 10 by the motion detector 35. When the proximity of the command object 17 is within a minimum threshold distance of the location of a command point 27 and over a predetermined period of time, the CPU 10 performs the chosen command.

Parallel processing is performed by the CPU 10 to determine whether the command object 17 has also performed a contact code. The processor saves the signals representing the locations of the command object 17 for a minimum amount of time. Motions by the command object 17 within the predetermined time are compared to contact codes to determine whether there is a match. The location of the performance of a contact code and its type is monitored to correlate it to the desired command. When the CPU 10 determines that a contact code has been performed the type of contact code and whether it was performed within a minimum threshold distance of a command point 27 is determined. The type of contact code, whether it was performed within a minimum distance of a command point 27 and what command point 27 it was performed at, enables the CPU 10 to compare these factors with predetermined codes to determine the command desired. After the desired command is determined, a command signal is sent to the CPU 10 to implement the desired command. 100101 Such holographic interfaces are known in the art. One such system is shown in my prior patent, U.S. Pat. No. 6,031,519, issued Feb. 29, 2000, which is hereby incorporated by reference in its entirety. Such systems, though, are typically limited to acting as simple computer interfaces, e.g., substituting for a keyboard, mouse, etc. associated with a conventional personal computer. It would be desirable to be able to provide the convenience, efficiency, and combined data display and input interface of a holographic display to physical or other systems to the computer which require manipulation by the user for sending control signals or other information (e.g., feedback data), such as operation of a remote robotic arm or controls of a vehicle.

Thus, a holographic interface for manipulation solving the aforementioned problems is desired.

### SUMMARY OF THE INVENTION

The holographic interface for manipulation (as described above) includes a holographic display unit for constructing and displaying a hologram and a motion detector for detecting movement and location of a physical command object, such as a user's finger or hand, relative to the displayed hologram. The motion detector is in communication with a controller for converting the detected location of the physical command object relative to its position with respect to the displayed hologram into a command signal. The command signal is then used to control the computer or transmitted to an external device, such as a robotic arm in a remote place. The hologram may be a representation of the physical controls of the external device. As a further example, the holographic interface for manipulation may be used locally or onboard for controlling a vehicle.

These and other features of the present invention will become readily apparent upon further review of the following specification and drawings.

### BRIEF DESCRIPTION OF THE DRAWINGS

FIG. 1 is an environmental, perspective view of a holographic interface for manipulation according to the present invention.

FIG. 2 is an environmental, perspective view of a prior art holographic interface system.

FIG. 3 is an enlarged view of the prior art holographic interface system of FIG. 2.

FIG. 4 is a block diagram illustrating system components of the holographic interface for manipulation according to the present invention.

FIG. 5 is an environmental, perspective view of an alternative embodiment of a holographic interface for manipulation according to the present invention.

Similar reference characters denote corresponding features consistently throughout the attached drawings.

### DETAILED DESCRIPTION OF THE PREFERRED EMBODIMENTS

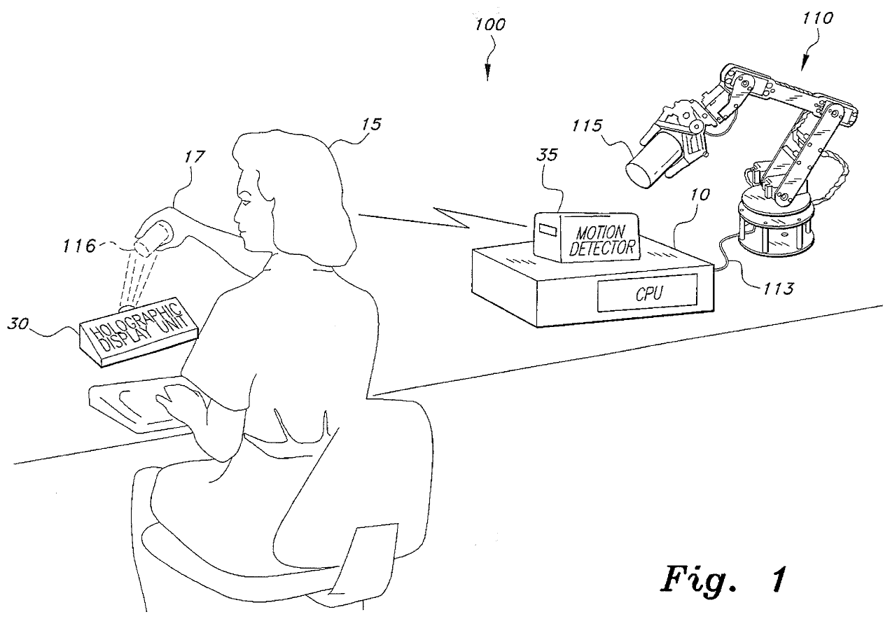

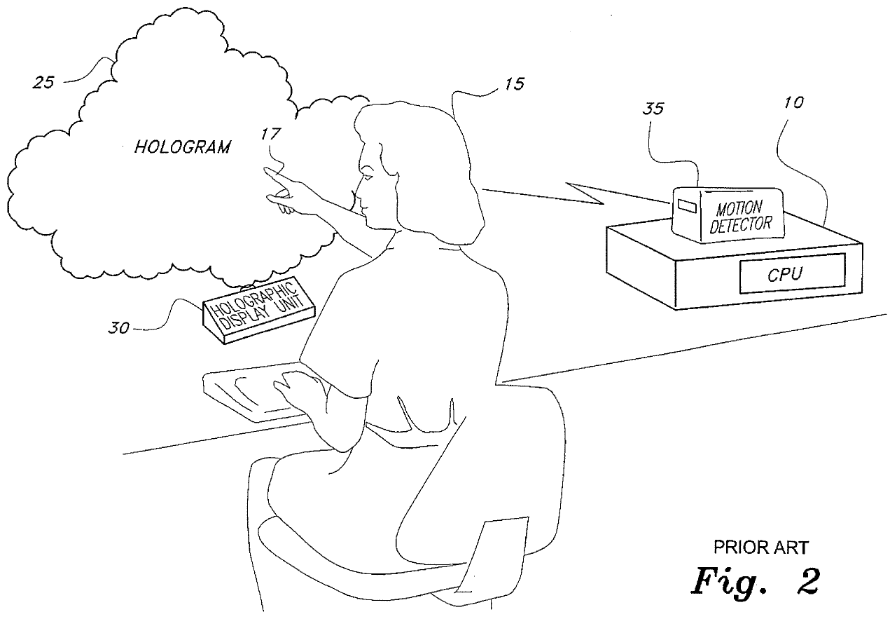

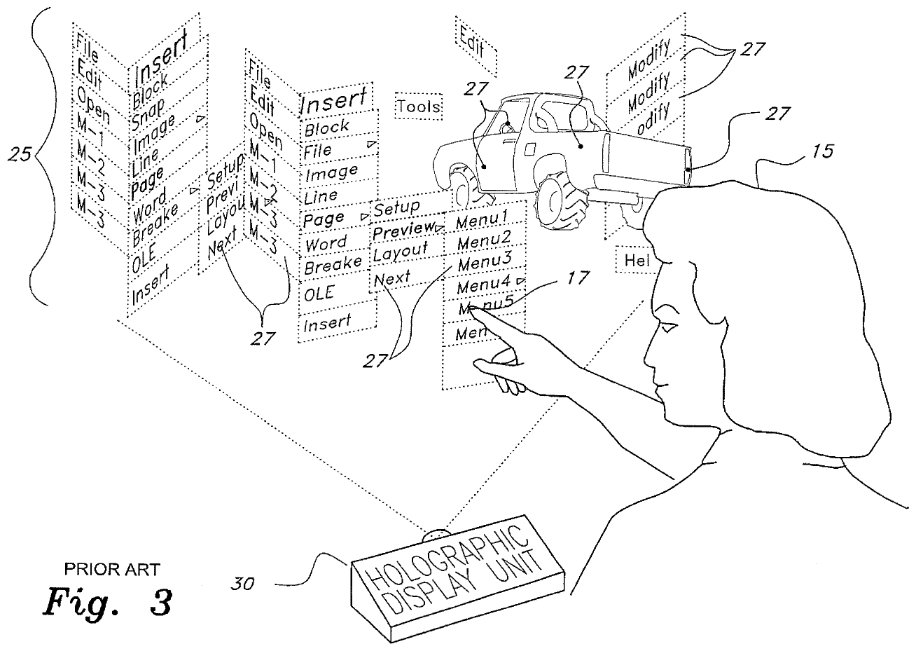

A shown in FIG. 1, the holographic interface for manipulation 100 operates in a manner similar to the prior art system described above and shown in FIGS. 2 and 3, including holographic display unit 30, motion detector 35 and CPU 10. However, the CPU further communicates with an external device 110. In the example shown in FIG. 1, the external device 110 is a conventional robotic arm gripping a physical object, e.g., a cup 115, The holographic display unit 30 projects a holographic image 116, representative of the physical object 115, and the user's hand serves as the command object 17, as described above, to manipulate the holographic image 116. The CPU 10 interprets motion of the command object 17 (i.e., the user's hand) with regard to the holographic image 116, as described above with relation to FIGS. 2 and 3, to transmit a command signal to the robotic arm 110 for real, physical manipulation of the physical object 115. The hologram may be a representation of the physical controls of the external device (or a simulation thereof), e.g., a control panel, a cockpit, a remote control device, etc., and the holographic image 116 being manipulated by the command object 17 may be a physical control, e.g., a steering wheel, a button on a remote control, a switch, or other physical control of the external device. In FIG. 1, the CPU 10 is shown as being in communication with robotic arm 110 by a wired line or Ethernet cable 113. However, it should be understood that the CPU 10 may transmit control signals to and receive feedback signals from the external device 110 by any suitable transmission path, including wired or wireless transmission. It should be understood that the external device may be any suitable external device or system, or may be a computer, computer system or the like for interpreting control signals and delivering control commands to an external system or, alternatively, for interpreting control signals to a computerized simulation of an external device or system.

The holographic interface for manipulation 100 controls CPU 10 a manner similar to a conventional computer interface (monitor, keyboard, mouse, etc.), exchanging interface command signals with the CPU 10. The CPU 10 then, in turn, may transmit command and control signals to an external device or system. It should be understood that the external device may be any type of external device, system or computer/computer system, as will be described in greater detail below.

In addition to motion detection, it should be understood that any suitable type of auxiliary control interface, as is conventionally known, may be integrated into the system, such as speech or voice recognition hardware and/or software; conventional computer interfaces such as keyboards, mice, etc.; wireless remote control signals, or the like. Thus, auxiliary control signals by any additional type of controller or interface may also be used and transmitted to the external device.

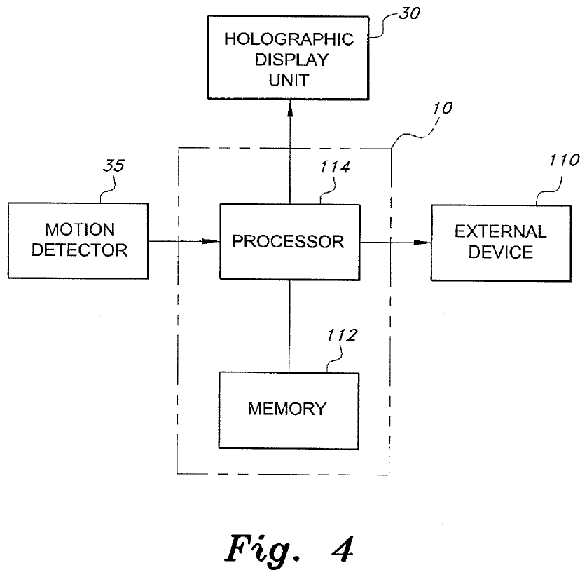

It should be understood that the CPU 10 may be part of or replaced by any suitable computer system or controller, such as that diagrammatically shown in FIG. 4. Data is entered via the motion detector 35 communicating with the CPU 10, as described above, and may be stored in memory 112, which may be any suitable type of computer readable and programmable memory, which is preferably a non-transitory, computer readable storage medium. Calculations are performed by a processor 114, which may be any suitable type of computer processor. The processor 114 may be associated with or incorporated into any suitable type of computing device, for example, a personal computer or a programmable logic controller. The motion detector 35, the processor 114, the memory 112, the holographic display unit 30, the external device 110, and any associated computer readable recording media are in communication with one another by any suitable type of data bus, as is well known in the art.

Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (H-DD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media include all computer-readable media, with the sole exception being a transitory, propagating signal.

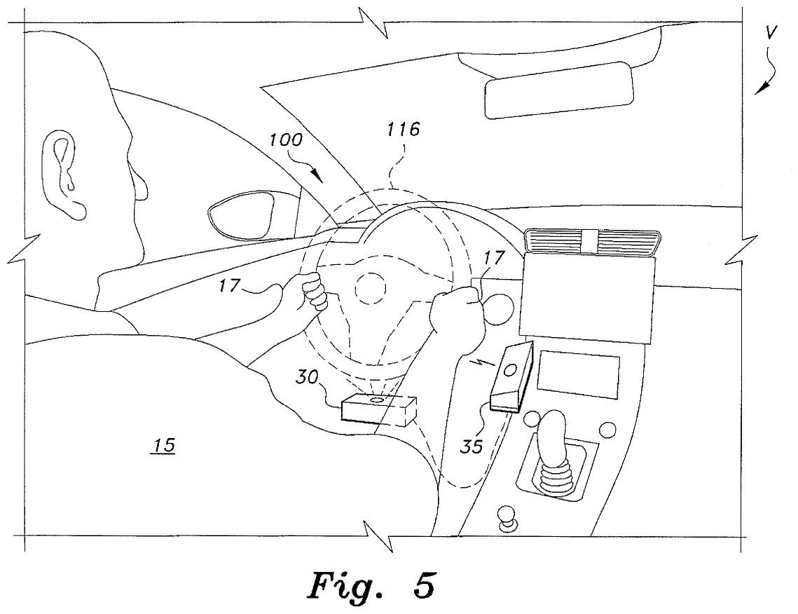

It should be understood that the robotic arm shown in FIG. 1 is shown for exemplary purposes only, and that the holographic interface for manipulation 100 may be used to control any remote system (such as the robotic arm of FIG. 1, or any other type of machinery that may be used in a remote plant or external software system such as a simulation) or to replace local or onboard controls or interfaces. As a further example, FIG. 5 illustrates system 100 integrated into a vehicle V, the holographic display unit 30 being mounted within the vehicle's cabin for projecting the holographic image 116, which is in the form of a steering wheel in this example. The motion detector 35 is similarly mounted within the vehicle's cabin for detecting the user's manipulation of the holographic steering wheel image 116. As shown, the user may use his or her hands in a conventional steering manner, so that the hands serve as the command objects 17 such that the motion detector 35 will detect the user's conventional steering movements with respect to the holographic steering wheel image 116. The motion detector 35 transmits the received motion signals to the CPU 10, which may be mounted in any suitable location within vehicle V for transmitting control signals to the external device 110, which, in this example, is the vehicle's steering system. The CPU 10 may discriminate between general motions made by the command objects 17 (i.e., the user's hands in this example) and motions specific to the steering of a vehicle. For example, if the user makes back-and-forth linear motions with his or her hands, the CPU 10 will not interpret this as steering-related and will not transmit a control signal to the vehicle's steering system. The CPU 10 can be programmed to only interpret clockwise or counter-clockwise rotational movement of the user's hands as steering-related, and only transmit a control signal when such motion is detected by the motion detector 35, for example.

It should be understood that FIGS. 1 and 5 only illustrate examples of the use of the holographic interface for manipulation 100, and that the holographic interface for manipulation 100 may be used as an interface for any suitable system, including remote systems, such as remote plants, or local or onboard systems, such as the exemplary vehicle V of FIG. 5, or as a further example, a fighter jet. In a more complex system, such as a fighter jet, the holographic display unit 30 could be used to project fighter jet controls to be manipulated by the user, as well as heads-up holographic information, The CPU 10 may be in communication with information systems associated with the jet, such as radar signal processing systems and the like. It should be understood that in addition to on-board control, such as in vehicle V or in the example of a fighter jet, the holographic interface for manipulation 100 may also be used in conjunction with a mock-up for purposes of training or simulation.

It should be further understood that the holographic interface 100 is not limited to the control of external devices, but may also be used as a direct interface for a computer, computer system, computer network or the like. The holographic interface 100 allows the user to interact with holograms of objects of interest directly, for viewing, arranging for design purposes, editing and the like, particularly for applications running on the computer, including conventional computer applications, simulations and the like.

Further, it is important to note that the holographic interface for manipulation 100 provides the user with the capability to directly manipulate holograms that represent controls on systems, whether physical or not, that are external to the computer running the interface. For example, in FIG. 1, the user is not manipulating a hologram of the robotic arm 110, but is rather manipulating a hologram of the object 115 being manipulated by the robotic arm. This is one use of the system, whereas the example of FIG. 5 illustrates another use, where the user manipulates a hologram of the controls of the external device (a vehicle in this example). It should be further understood that the external device may be another computer or computerized system, such that the external control corresponds to external software control, thus forming a remote computer interface.

It should be further understood that the remote device, such as the exemplary robotic arm 110 of FIG. 1, may include sensors, transmitters or any other necessary or desired auxiliary or peripheral equipment, or may be in communication with such at the remote location. Using the example of FIG. 1, as the user's hand 17 moves toward the hologram of the object 116, the robotic arm 110 moves toward the actual object 115. In addition to system 100 tracking the relative location of the user's hand 17 via sensor 35, additional external sensors may be used to track the location of the hand 17 (or some other command object) relative to both the position of the robotic arm 110 and the physical object 115, as well as translating the hand movements into actual physical pressure on the object 115.

It is to be understood that the present invention is not limited to the embodiments described above, but encompasses any and all embodiments within the scope of the following claims.

I claim:

1. A holographic interface for manipulation, comprising:
a holographic display unit for constructing and displaying a hologram;
a motion detector for detecting movement and location of a physical command object relative to the displayed hologram;
a controller in communication with the motion detector for converting the detected location of the physical command object relative to its position with respect to the displayed hologram into a command signal when the command object is at or near a contact point in the hologram or performs a contact code; and
means for transmitting the command signal to an external device controllable by the command signal.

2. The holographic interface for manipulation as recited in claim 1, wherein the hologram visually represents a control interface associated with the external device.

3. The holographic interface for manipulation as recited in claim 1, wherein the hologram visually represents at least one object being manipulated by the external device.

4. The holographic interface for manipulation as recited in claim 1, wherein the hologram visually represents at least one physical control of the external device.

5. The holographic interface for manipulation as recited in claim 1, further comprising an auxiliary control interface for transmitting auxiliary control signals to the external device.

6. A method of controlling a device by holographic interface, comprising the steps of:
displaying a hologram;
detecting movement and location of a physical command object relative to the displayed hologram;
processing the detected movement and location of the physical command object relative to the displayed hologram;
converting the processed location of the physical command object into a command signal when the command object is at or near a contact point in the hologram or performs a contact code; and
transmitting the command signal to an external device controllable by the command signal.

7. The method of controlling a device according to claim 6, wherein the hologram represents a holographic image of physical controls of the external device, the method further comprising the steps of:
manipulating the holographic image of one of the physical controls of the external device;
detecting the manipulation of the physical control;
generating a command signal commanding the external device to perform an action corresponding to manipulation of the physical control; and
transmitting the command signal to perform the action to the external device, the external device performing the action after receiving the command signal.

8. The method of controlling a device according to claim 7, wherein the external device is a robotic device.

9. The method of controlling a device according to claim 7, wherein the external device is a vehicle.

10. The method of controlling a device according to claim 7, further comprising the steps of:
receiving an auxiliary command;
generating an auxiliary command signal commanding the external device to perform an action corresponding to the auxiliary command; and
transmitting the auxiliary command signal to perform the action to the external device, the external device performing the action after receiving the auxiliary command signal.

11. A method of controlling a device by holographic interface, comprising the steps of:
displaying a hologram;
detecting movement and location of a physical command object relative to the displayed hologram;
processing a contact code based on the detected movement and location of the physical command object;
converting the processed contact code into a command signal; and
transmitting the command signal to an external device controllable by the contact signal.

12. The method of controlling a device according to claim 11, wherein the hologram represents a holographic image of physical controls of the external device, the method further comprising the steps of:
manipulating the holographic image of one of the physical controls of the external device;
detecting the manipulation of the physical control;
generating a command signal commanding the external device to perform an action corresponding to manipulation of the physical control; and
transmitting the command signal to perform the action to the external device, the external device performing the action after receiving the command signal.

13. The method of controlling a device according to claim 12, wherein the external device is a robotic device.

14. The method of controlling a device according to claim 12, wherein the external device is a vehicle.
